(19) United States
(12) Patent Application Publication
(10) Pub. No.: US 2006/0074723 A1
(43) Pub. Date: Apr. 6, 2006

(54) EBCL solution

(76) Inventor: Edith E. Boothe, Avenel, NJ (US)

Correspondence Address: EDITH E. BOOTHE, 3608 SOUTH VILLAGE DRIVE, AVENEL, NJ, 07001, US

(21) Appl. No.: 10/952,340

(22) Filed: Sep. 29, 2004

(51) Int. Cl. G06Q 40/00

(52) U.S. Cl. 705/4

(57) ABSTRACT

When anyone takes out a loan, that person should have the option to give permission to have his/her functional organs sold in the event of his/her death to pay off his/her debt in the event that such debt would be a burden to his/her loved ones/next of kin.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

In today's society, many people are carrying significant debt that would be passed on to their families in the event of their death. When anyone takes out a loan, that person should have the option to give permission to have his/her functional organs sold in the event of his/her death to pay off his/her debt in the event that such debt would be a burden to his/her loved ones/next of kin. For this invention, debt refers to the difference between a deceased's assets and his/her liabilities.

### BRIEF SUMMARY OF THE INVENTION

EBCL Solution will eliminate the burden of paying off debt passed on to families by a deceased loved one, will alleviate the need for an organ recipient waiting list, will decrease the number of patients dying annually waiting to receive a functional organ, will be available to anyone regardless of where he/she resides in the United States. Relatives will mourn in peace without the interruptions of debt collectors calling to convey their sympathy but at the same time, letting the relatives know that their loved one's debt is still outstanding and they are seeking repayment. EBCL Solution promotes healthy living as debtors will be aware that if their organs are not healthy at the time of their death, the organs will not be qualified for sale and their loved ones will be left with the burden of paying off their debt. There is no monetary cost associated with EBCL Solution. No payment is required to benefit from it. It only requires the debtor to kick bad habits that could be detrimental to his/her organs/health.

### BRIEF DESCRIPTION OF THE SEVERAL VIEWS OF THE DRAWING

Not Applicable

### DETAILED DESCRIPTION OF THE INVENTION

When anyone takes out a loan, that person should have the option to give permission to have his/her functional organs sold in the event of his/her death to pay off his/her debt in the event that such debt would be a burden to his/her loved ones/next of kin. In the following description, debt refers to the difference between a deceased assets and his/her liabilities. The procedure for the EBCL Solution is as follows:
On each loan application that is filled out by a prospective debtor, there should be a box to be checked giving permission for the EBCL Solution.
Lenders/creditors should have to apply to the State in which they do business to obtain a permit to offer the EBCL Solution feature. Restrictions such as the nature of the lender/creditor business, etc. should apply.
Every lender/creditor that has this box checked by a debtor on a loan application should have entitlement to the proceeds from the sale of the debtor's organs.
The proceeds from the sale of organs should be distributed to lenders/creditors in percentages depending on the percentage of the debtor's outstanding loan to such lender/creditor. (Similar to the distribution of assets in a bankruptcy case.)
In the event that a prospective organ purchaser does not have the funds to purchase a needed organ for himself/herself or a loved one, and is not qualified to get an organ at no cost, a lender/creditor should have the option to extend credit, if qualified, to such person at a State or Federally approved interest rate.
The cost of each organ should be regulated by the State or Federal Government.
The EBCL Solution should be an option available to the debtor throughout his/her lifetime or the lifetime of the debt as long as he/she is of sound mind.
In the event that the proceeds from the sale of the debtor's organs are not sufficient to pay off the debtor's debt, the lender/creditor should still be permitted to seek repayment of the debt using other legal methods. However, only a percentage (determined by the State or Federal Government) of the total balance of the debt should be able to be claimed by the lender/creditor. The lender/creditor will have the option to settle the balance of the debt at an amount less than such percentage of the debt.
The EBCL Solution should be applicable to funeral expenses for persons 18 years of age or older in the event of unexpected death and family financial inability to cover such expenses. In such event, the next of kin will be able to give permission for the EBCL Solution if same was not given by the deceased.
The sale of organs should be offered on a wholesale basis to hospitals or other approved medical institutions for future sale in the event a prospective purchaser is not available at the time of sale. The resale cost of organs should be no more than the retail cost available to regular purchasers or a percentage markup cost approved by the State or Federal Government.
The sale of organs should be ethically regulated and organizations/companies with interest of being a part of such business should be State/Federal Licensed and have a facility approved to conduct such business.
Permission should only be granted for the sale of a debtor's organs up to the amount of his/her outstanding debt. The proceeds from organs sold should not go over a percentage approved by the State or Federal Government of the total debt owed by the debtor with any overage going to the debtor's estate. The debtor can choose to have remaining healthy/functional organs donated to recipients who are financially unable to purchase them.
Proceeds from the sale of a debtor's organs should be determined if taxable by the State or Federal Government.
Federal/State funds could be provided to assist patients who are in need of functional organs to save their lives but are financially unable to receive these organs. Special medical institutions should be designated to offer such service to these patients.
All donated organs should go directly to patients who, based on their earnings or other necessary, obligatory financial restraints are unable to afford the cost of functional organs needed to save their lives or the life of a dependent.
EBCL Solution will not have an adverse effect on the option to choose to be an organ donor but will help to promote and raise more awareness of it.
If a debtor chooses to grant permission for the sale of his/her functional organs upon his/her death to pay off his/her debt in the event that such debt would be a burden to his/her loved ones/next of kin by checking the appropriate box on a loan application, he/she should name an executor who will have this wish executed upon the debtor's death. The executor should be notified of this responsibility as soon as possible after the approval of such loan to the debtor and given the option to accept or decline such responsibility. If the debtor is unable to name an executor who is willing to accept this responsibility, the debtor will be deemed ineligible for the EBCL Solution.
Eligibility for the EBCL Solution requires that a debtor at the time of his/her death has a minimum of $10,000 in outstanding cumulative debt which can include funeral expenses for persons 18 years of age or older only in the event of unexpected death and family financial inability to cover funeral expenses.
The health/functionality of any organ for sale should be determined based on the recommendation(s) of a trained medical professional in the organ transplant field.

What is claimed is:

1. A method of eliminating the burden of paying off debt passed on to families by a deceased loved one

2. EBCL Solution will alleviate the need for an organ recipient waiting list.

3. EBCL Solution will decrease the number of patients dying annually waiting to receive a functional organ.

4. EBCL Solution will be available to anyone regardless of where he/she resides in the United States.

5. EBCL Solution will relieve the burden left on relatives after the death of a loved one to pay off his/her debt.

6. Relatives will mourn in peace without the interruptions of debt collectors calling to convey their sympathy but at the same time, letting the relatives know that their loved one's debt is still outstanding and they are seeking repayment.

7. EBCL Solution promotes healthy living as debtors will be aware that if their organs are not healthy at the time of their death, the organs will not be qualified for sale and their loved ones will be left with the burden of paying off their debt.

8. There is no monetary cost associated with EBCL Solution. No payment is required to benefit from it. It only requires the debtor to kick bad habits that could be detrimental to his/her organs/health.
